(19) United States
(12) Patent Application Publication
(10) Pub. No.: US 2026/0355903 A1
(43) Pub. Date: Nov. 12, 2026

(54) AUTONOMOUS BLASTING ROBOT DEVICE

(71) Applicant: Seoul Dynamics, Seongnam-si (KR)

(72) Inventors: Geosong LEE, Seongnam-si (KR); Yongseung LEE, Seongnam-si (KR); Seunghan CHUNG, Seongnam-si (KR); Gihyuk CHO, Seongnam-si (KR); Sunghoon KANG, Seongnam-si (KR)

(21) Appl. No.: 19/671,068

(22) Filed: May 7, 2026

(30) Foreign Application Priority Data
May 7, 2025 (KR) 10-2025-0059239
Apr. 30, 2026 (KR) 10-2026-0079208

(51) Int. Cl. B24C 3/06; B24C 7/00; B25J 9/16; B25J 11/00; B25J 13/08

(52) U.S. Cl. CPC B24C 3/06; B24C 7/0053; B25J 9/1666; B25J 9/1697; B25J 11/0065; B25J 13/089

(57) ABSTRACT

An autonomous blasting robot device for surface treatment of a work surface may include a main frame, a traveling unit movably coupled to the main frame, a blasting unit configured to spray abrasive media toward the work surface, a scattering suppression unit surrounding at least a portion of the blasting unit and reducing outward scattering of the abrasive media, and a control unit configured to control the traveling unit and the blasting unit. The control unit may be configured to adjust at least one of a position, a height, a posture, and a spray angle of the blasting unit in response to a shape of the work surface.

### CROSS-REFERENCE TO RELATED APPLICATIONS

This application claims priority to and the benefit of Korean Patent Application No. 10-2026-0079208, filed on Apr. 30, 2026, in the Korean Intellectual Property Office, which claims priority to Korean Patent Application No. 10-2025-0059239, filed on May 7, 2025, in the Korean Intellectual Property Office, the entire contents of each of which are incorporated herein by reference.

### TECHNICAL FIELD

The present disclosure relates to a blasting robot device used for surface treatment work on ships and large structures. More particularly, the present disclosure relates to an autonomous blasting robot device and a control method thereof, wherein the robot performs surface treatment by autonomously traveling in an environment in which grit or other abrasive media is dispersed, controlling a blasting unit in response to a shape of a work surface, avoiding obstacles, selecting an appropriate traveling mode from among a plurality of traveling modes, and performing remote control when necessary.

### BACKGROUND

In general, before a painting process is performed, an outer plate or an inner plate of a ship may undergo a blasting process in order to remove rust, foreign substances, weld beads, dust, and the like adhered to the surface. In such a blasting process, grit is sprayed at high speed onto the surface of a steel plate to form a surface having a predetermined roughness, thereby improving adhesion of paint coating or primer coating. Even after painting has been completed, blasting may again be performed when an existing paint layer is removed for repainting, maintenance, or repair.

Conventional blasting work has mainly been performed by an operator directly manipulating equipment or by using fixed or semi-automatic equipment. Such approaches involve a high risk of safety accidents for operators, require a high degree of labor intensity, and have low working efficiency. In particular, at a large work site such as a shipyard, the work area is wide and the working environment is poor, resulting in increased worker fatigue and making it difficult to secure uniform work quality.

Recently, industrial robots to which autonomous traveling technology is applied have been researched and developed in various fields in order to improve work efficiency and safety. An autonomous traveling robot can recognize a surrounding environment while traveling and can perform a target task while avoiding obstacles, and therefore has been proposed for surface inspection, cleaning, painting, and other work on large structures. Such a robot generally recognizes its surrounding environment using various sensors, such as LiDAR, cameras, and ultrasonic sensors, and generates and controls a traveling path based on the recognition result. However, a blasting work environment is characterized by grit and dust being dispersed in the air, which can significantly degrade sensor recognition performance and thereby reduce the stability of autonomous traveling.

### SUMMARY

In a shipyard, block supports for supporting ship blocks are arranged in various shapes and sizes. If an autonomous robot cannot accurately recognize and avoid such supports, collisions or interruption of work may occur. In addition, work surfaces and inner plates of large structures often include curved surfaces rather than only flat surfaces, and therefore it can be difficult for a blasting unit to maintain a constant spacing from, or a close-contact state with, the surface of the steel plate. Thus, although attempts have been made to apply autonomous traveling robots for automating and autonomously performing blasting work, various technical problems remain for practical field application due to poor working environments, limitations in sensor recognition, complicated obstacle structures, and the need to respond to curved steel plates.

Based on the foregoing, the present disclosure provides an autonomous blasting robot device that can stably perform blasting work on a steel-plate surface of a ship in a shipyard environment in which grit is dispersed and complex work obstacles are present.

According to one embodiment, an autonomous blasting robot device for surface treatment of a ship block may include a main frame having an internal mounting space, a traveling unit coupled to a lower portion of the main frame to perform traveling and steering, a blasting unit installed at an upper front portion of the main frame to spray grit or other abrasive media, a control unit disposed at a rear portion of the main frame and configured to control the traveling unit and the blasting unit, a main battery disposed inside or at a lower portion of the main frame to supply electric power, and a sensing unit including a camera and a LiDAR sensor for obstacle recognition.

In one embodiment, the blasting unit may include a blasting motor for spraying grit and a grit valve for adjusting a spray amount.

In one embodiment, the grit valve may be operated by at least one of an electric, hydraulic, pneumatic, or manual mechanism.

In one embodiment, a sealing blasting unit box, a scattering-prevention cover, and a brush for preventing outward scattering of grit may be disposed at a lower side of the blasting unit.

In one embodiment, the device may include a hydraulic unit and a hydraulic cylinder for adjusting a height of an upper plate of the blasting unit, a damper for maintaining close-contact force with the work surface, and an angle adjustment mechanism for adjusting a spray angle.

In one embodiment, the control unit may be configured to vary a position of the blasting unit and the angle adjustment mechanism in response to a curved shape of the work surface.

In one embodiment, an air compressor for supplying compressed air to the blasting unit and a cooling system for cooling internal equipment may be disposed inside the main frame. The cooling system may include a cooling water tank, a cooling water pump, a cooling radiator, and a cooling-water piping line connecting the same.

In one embodiment, the traveling unit may further include a plurality of casters for rotation and support, a guide caster for traveling guidance, a driving motor and a reducer for transmitting power, and a steering motor and a reducer for changing direction.

In one embodiment, the device may include a floor brush installed at a lower end of the main frame to remove foreign substances, and an air cylinder configured to raise and lower the floor brush.

In one embodiment, the device may include a power distribution unit (PDU) for distributing power from the main battery, a reactor and a voltage filter for voltage stabilization, a blasting inverter and a main inverter for driving the blasting motor, and a motor drive for controlling the driving motor and the steering motor.

In one embodiment, an illumination lamp for nighttime work or work inside a dark ship may be installed at a front or side portion of the main frame, and the sensing unit may be configured to identify obstacles by preferentially using a vision camera rather than a LiDAR sensor in an environment in which grit is dispersed.

In one embodiment, the control unit may be configured to recognize obstacles including ship block supports based on information obtained from the sensing unit, generate an avoidance path, and perform an avoidance maneuver based on autonomous-traveling labeling learning data according to the shape and size of the ship block supports.

In one embodiment, the control unit may be configured to select a traveling mode suitable for a work situation from among a plurality of traveling modes including straight movement, turning movement, in-place rotation, parallel movement, and diagonal movement, and to switch traveling modes within a preset short mode-switching time.

In one embodiment, the sensing unit may be configured to preferentially reflect information from a sensor having high reliability among a plurality of sensors in an environment in which visibility is reduced due to grit dispersion or dust.

In one embodiment, the autonomous blasting robot device may further include a communication unit for communication with a remote device, and the control unit may be configured to perform autonomous traveling and autonomous work, and, when necessary, to receive a remote control command from the remote device and control at least one of traveling or blasting work according to the command.

In one embodiment, through the communication unit, one operator may simultaneously monitor the states of a plurality of autonomous blasting robots and, when necessary, perform remote manual control or semi-autonomous intervention control for a particular robot.

Embodiments of the present disclosure provide an effect of enabling blasting work on a steel-plate surface of a ship to be stably performed through autonomous traveling even in a poor working environment in which grit is dispersed.

Embodiments of the present disclosure also provide an effect of reducing collision risk during work by recognizing and avoiding obstacles that are arranged in various shapes and positions at a shipyard.

Accordingly, automation and efficiency improvements in blasting work can improve operator safety and secure uniform surface treatment quality.

In addition, uniform blasting quality can be secured by variably controlling the position, height, and angle of the blasting unit in response to a curved shape of the work surface.

In addition, the device can flexibly respond to various working environments by providing a plurality of traveling modes including straight movement, turning movement, in-place rotation, parallel movement, and diagonal movement, and by selectively switching to a mode suitable for the work situation.

In addition, through remote monitoring, one operator can simultaneously monitor a plurality of blasting robots and, when necessary, intervene by remote control with respect to a particular robot, thereby maximizing work efficiency.

The effects obtainable from the present disclosure are not limited to the effects mentioned in connection with the various embodiments. Other effects not expressly mentioned will be clearly understood by a person having ordinary skill in the art from the following description.

### BRIEF DESCRIPTION OF THE DRAWINGS

FIG. 1 illustrates an example of an autonomous blasting robot device according to an embodiment.

FIG. 2 illustrates another example view of an autonomous blasting robot device according to an embodiment.

FIG. 3 illustrates another example view of an autonomous blasting robot device according to an embodiment.

FIG. 4 illustrates another example view of an autonomous blasting robot device according to an embodiment.

FIG. 5 illustrates another example view of an autonomous blasting robot device according to an embodiment.

FIG. 6 illustrates another example view of an autonomous blasting robot device according to an embodiment.

FIG. 7 illustrates a block configuration of an autonomous blasting robot device according to an embodiment.

In connection with the description of the drawings, identical or similar reference numerals may be used for identical or similar components.

### DETAILED DESCRIPTION

Hereinafter, embodiments of the present disclosure will be described in detail with reference to the drawings so that a person having ordinary skill in the art to which the present disclosure pertains can readily practice the disclosure. However, the present disclosure may be implemented in various different forms and is not limited to the embodiments described herein. In connection with the drawings, identical or similar reference numerals may be used for identical or similar components. In the drawings and related description, descriptions of well-known functions and configurations may be omitted for clarity and conciseness.

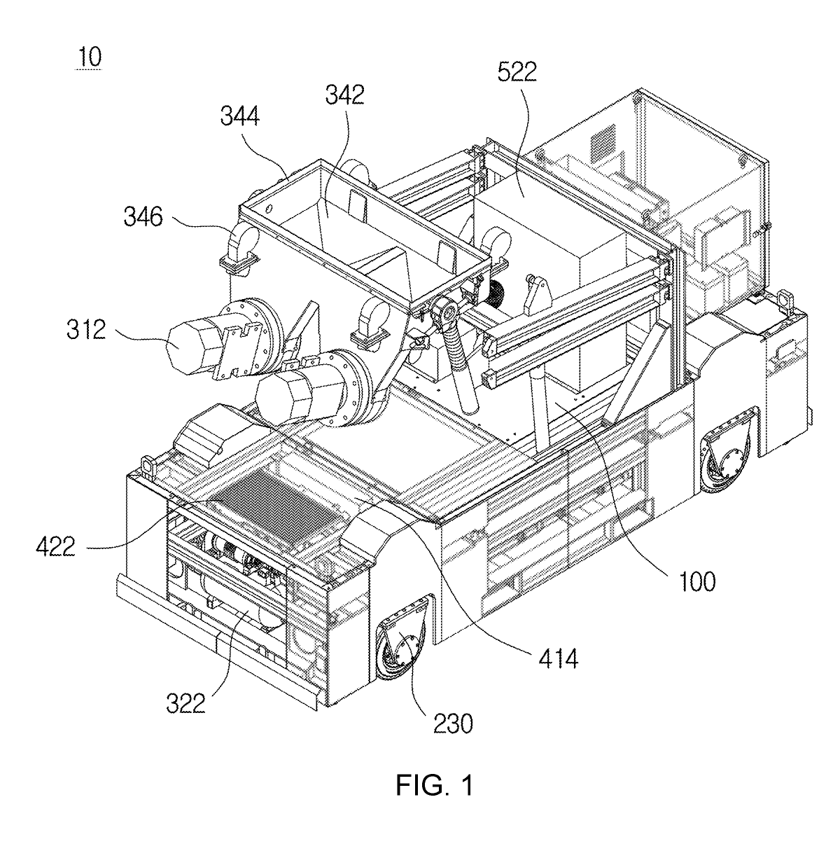

FIG. 1 is a perspective view schematically illustrating an overall structure of an autonomous blasting robot according to an embodiment of the present disclosure.

An autonomous blasting robot device 10 according to an embodiment may include a main frame 100, a blasting unit, a cooling system, an air compressor 322, a main inverter 522, and a caster module 230.

In one embodiment, the main frame 100 is a frame structure that supports the overall structure of the autonomous blasting robot device 10 and may have an internal space in which various pieces of equipment are mounted.

In one embodiment, the blasting unit may be disposed at an upper front portion of the main frame 100.

In one embodiment, the blasting unit may include a blasting motor 312 for spraying grit at high speed onto a work surface, a blasting unit box 342 for preventing outward scattering of grit, and a scattering-prevention cover 344.

In one embodiment, the blasting unit box 342 may be configured to seal a lower portion of the blasting motor 312 so as to prevent grit from scattering outside the work region.

In one embodiment, the scattering-prevention cover 344 may be coupled to an upper portion of the blasting unit box 342 to suppress upward scattering of grit.

In one embodiment, the air compressor 322 may be disposed inside the main frame 100 and configured to supply compressed air to the blasting unit.

In one embodiment, compressed air generated by the air compressor 322 may be transmitted to the blasting unit through a pneumatic line.

In one embodiment, the cooling system may be disposed inside the main frame 100.

In one embodiment, the cooling system may include a cooling radiator 422 and a cooling water tank 414.

In one embodiment, the cooling radiator 422 may be configured to dissipate heat generated during operation of internal equipment such as the blasting motor 312 and the air compressor 322.

In one embodiment, the cooling water tank 414 may store cooling water and supply cooling water to the cooling system.

In one embodiment, the main inverter 522 may be disposed at an upper rear portion of the main frame 100.

In one embodiment, the main inverter 522 may be configured to perform power conversion and operation control for the blasting motor 312 and other driving systems.

In one embodiment, the caster module 230 may be coupled to a lower portion of the main frame 100.

In one embodiment, the caster module 230 may include a plurality of casters and may be configured to support movement and direction change of the autonomous blasting robot device 10.

In one embodiment, a separate caster 346 may be disposed at a lower end of the blasting unit so that stable contact with the work surface can be maintained when the blasting unit moves.

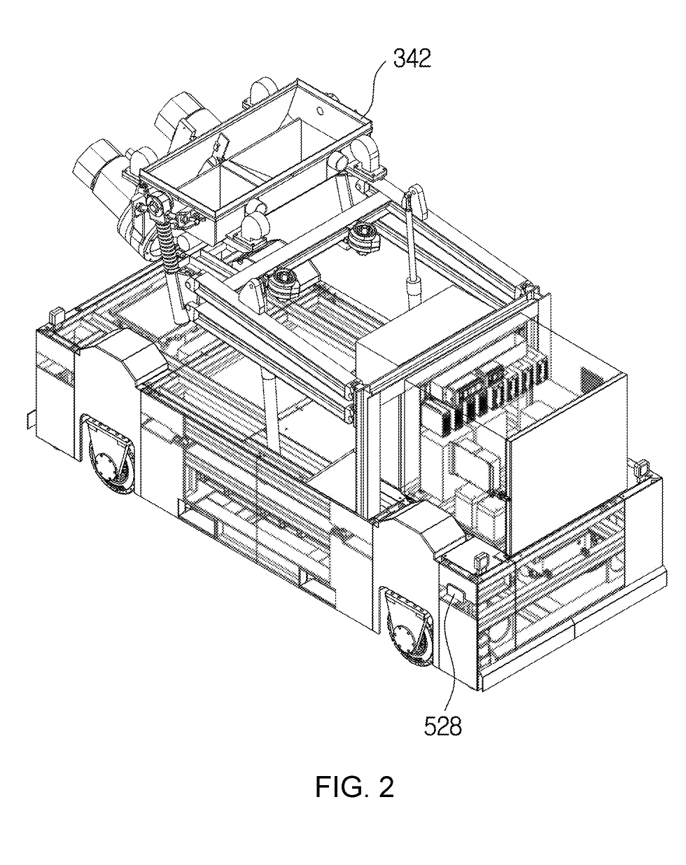

FIG. 2 illustrates a rear perspective view of the autonomous blasting robot device 10 according to an embodiment. In the description of FIG. 2, portions overlapping the description of FIG. 1 may be omitted.

The autonomous blasting robot device 10 according to an embodiment may include the blasting unit box 342 and a main battery charging terminal 528.

In one embodiment, the blasting unit box 342 may be disposed at an upper front portion of the main frame 100.

In one embodiment, the blasting unit box 342 may accommodate the blasting motor 312 and components related to grit spraying and may be formed as a sealing structure that prevents outward scattering of grit.

In one embodiment, the main battery charging terminal 528 may be disposed at a lower rear portion of the main frame 100.

In one embodiment, the main battery charging terminal 528 may be configured as an interface for connection to an external power source to charge the main battery 512. For example, during a non-working period of the autonomous blasting robot device 10, the main battery charging terminal 528 may be connected to an external charging device to supply charging power to the main battery 512.

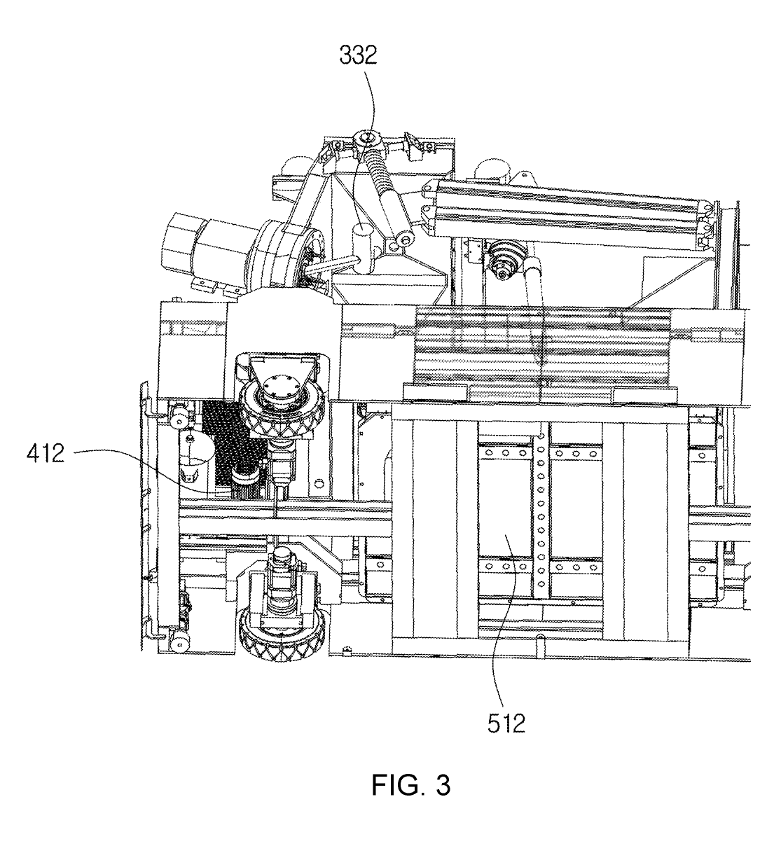

FIG. 3 is an enlarged side view of the autonomous blasting robot device 10 according to an embodiment and illustrates the blasting unit and related components.

According to an embodiment, a grit valve 332, the main battery 512, and a cooling water pump 412 may be disposed in the region illustrated in FIG. 3.

In one embodiment, the grit valve 332 may be disposed at an upper portion of the blasting unit.

In one embodiment, the grit valve 332 may be configured to adjust the amount of grit supplied to the blasting motor 312. For example, the grit valve 332 may be operated by at least one of an electric, hydraulic, pneumatic, or manual mechanism.

In one embodiment, the main battery 512 may be disposed inside the main frame 100.

In one embodiment, the main battery 512 may be configured as a large-capacity battery that supplies power to the entire system of the autonomous blasting robot device 10.

In one embodiment, power output from the main battery 512 may be distributed to each component through a power distribution unit 514.

In one embodiment, the cooling water pump 412 may be disposed at a lower portion of the main frame 100.

In one embodiment, the cooling water pump 412 may be configured to draw cooling water from the cooling water tank 414 and circulate the cooling water to the cooling radiator 422 and equipment to be cooled.

In one embodiment, the cooling water pump 412, the cooling water tank 414, and the cooling radiator 422 may be interconnected by a cooling-water piping line to form a water-cooled cooling system.

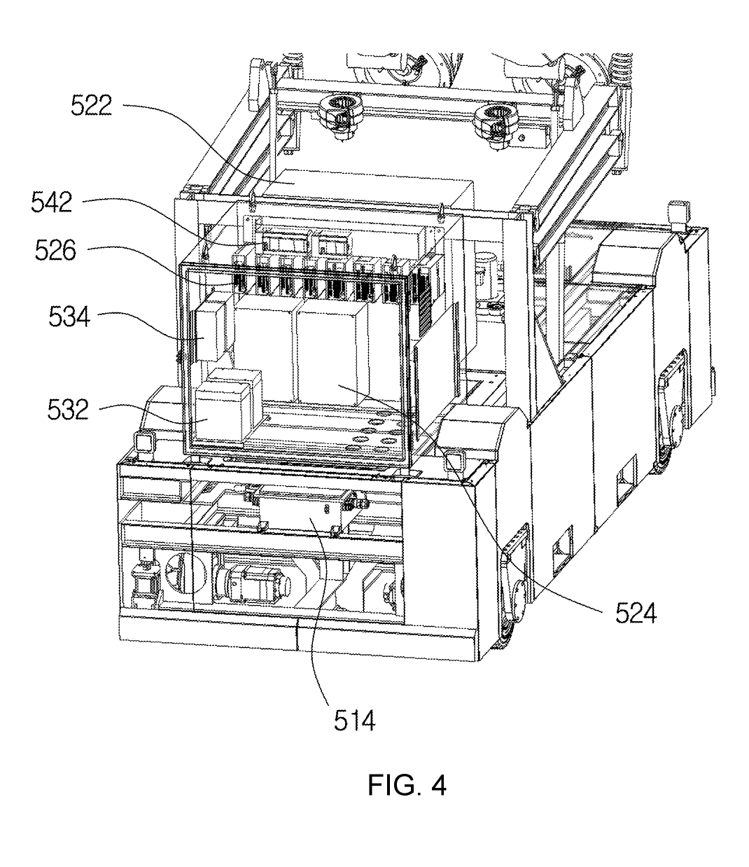

FIG. 4 illustrates an enlarged view of a rear control-unit region of the autonomous blasting robot device 10 according to an embodiment.

According to an embodiment, the control region may include the main inverter 522, a control PC 542, a sub-inverter 524, a traveling motor drive 526, a voltage filter 534, a reactor 532, and the power distribution unit 514.

In one embodiment, the main inverter 522 may be disposed at an upper rear portion of the main frame 100.

In one embodiment, the main inverter 522 may be configured to convert direct-current power supplied from the main battery 512 into alternating-current power and supply the alternating-current power to the blasting motor 312 and other driving systems.

In one embodiment, the sub-inverter 524 may be disposed at a side of the main inverter 522.

In one embodiment, the sub-inverter 524 may be configured as a dedicated inverter for driving the blasting motor 312.

In one embodiment, the sub-inverter 524 may be configured to precisely control rotational speed and torque of the blasting motor 312.

In one embodiment, the control PC 542 may be disposed at an upper rear portion of the main frame 100.

In one embodiment, the control PC 542 may be configured as a central control device for controlling overall operation of the autonomous blasting robot device 10. For example, the control PC 542 may generate a traveling path based on information acquired from the sensing unit and may control execution of blasting work.

In one embodiment, the traveling motor drive 526 may be configured to control operation of the driving motor and the steering motor.

In one embodiment, the traveling motor drive 526 may receive power from the main inverter 522 and may drive motors of a driving module 210 and a steering module 220.

In one embodiment, the reactor 532 and the voltage filter 534 may be disposed at a rear central portion of the main frame 100.

In one embodiment, the reactor 532 may be configured to suppress rapid fluctuations in current and secure stability of power supply.

In one embodiment, the voltage filter 534 may remove noise generated in the power line to prevent malfunction of the control PC 542 and the sensing unit.

In one embodiment, the PDU 514, or power distribution unit, may be disposed at a lower rear portion of the main frame 100.

In one embodiment, the PDU 514 may be configured to distribute power supplied from the main battery 512 to each component. For example, the PDU 514 may distribute required power to the main inverter 522, the sub-inverter 524, the traveling motor drive 526, the control PC 542, and the sensing unit.

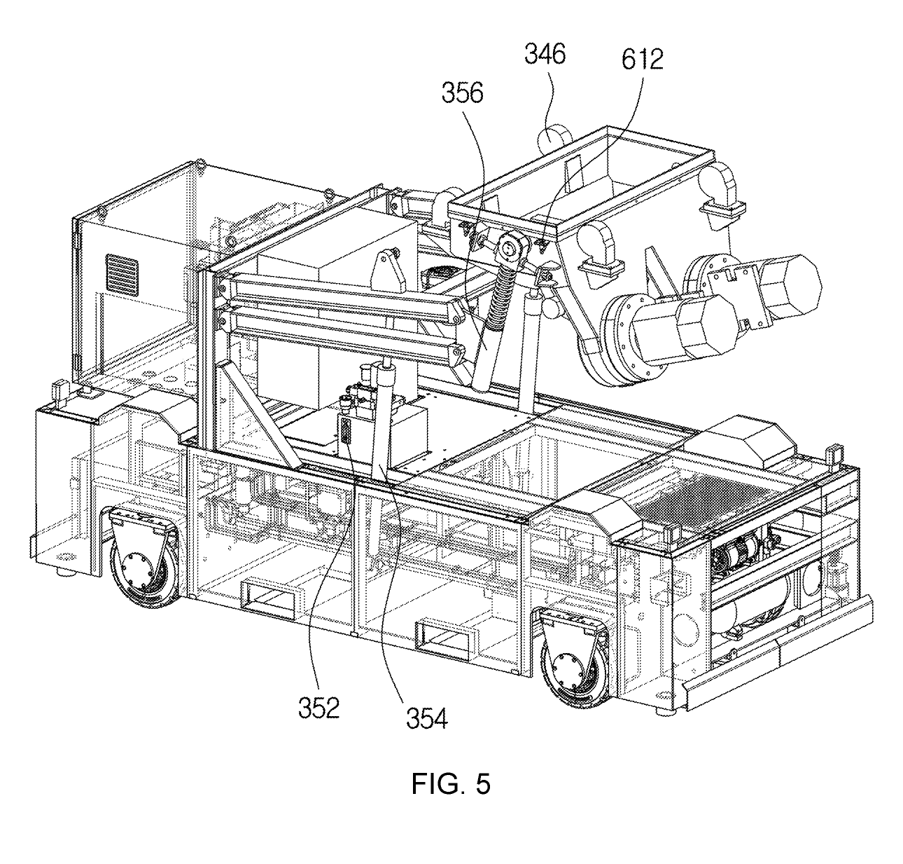

FIG. 5 illustrates an enlarged view of a blasting-unit position adjustment configuration and a portion of the sensing unit of the autonomous blasting robot device 10 according to an embodiment.

According to an embodiment, a hydraulic unit 352, a hydraulic cylinder 354, and a damper 356 may be provided to adjust the position of the blasting unit. In addition, an ultrasonic sensor 612 and a caster 346 may be disposed as a portion of the sensing unit and support components.

In one embodiment, the hydraulic unit 352 may be disposed at a lower portion of the main frame 100.

In one embodiment, the hydraulic unit 352 may be configured to supply hydraulic pressure to the hydraulic cylinder 354 and adjust the height of an upper plate of the blasting unit.

In one embodiment, the hydraulic cylinder 354 may be connected between the main frame 100 and the blasting unit.

In one embodiment, the hydraulic cylinder 354 may expand and contract in response to hydraulic pressure supplied from the hydraulic unit 352 to vary the height of the blasting unit. Accordingly, the position of the blasting unit may be adjusted in correspondence with the height of the work surface.

In one embodiment, the damper 356 may be disposed at an upper portion of the blasting unit.

In one embodiment, the damper 356 may be configured to maintain close-contact force between the blasting unit and the work surface. For example, the damper 356 may absorb small height variations of the blasting unit in response to unevenness or a curved shape of the work surface.

In one embodiment, the ultrasonic sensor 612 may be disposed in front of the blasting unit.

In one embodiment, the ultrasonic sensor 612 may measure a distance to the work surface or a front obstacle and provide distance information to the control unit.

In one embodiment, the caster 346 may be disposed at a front lower portion of the blasting unit.

In one embodiment, the caster 346 may be configured to support stable traveling when the blasting unit moves on the work surface.

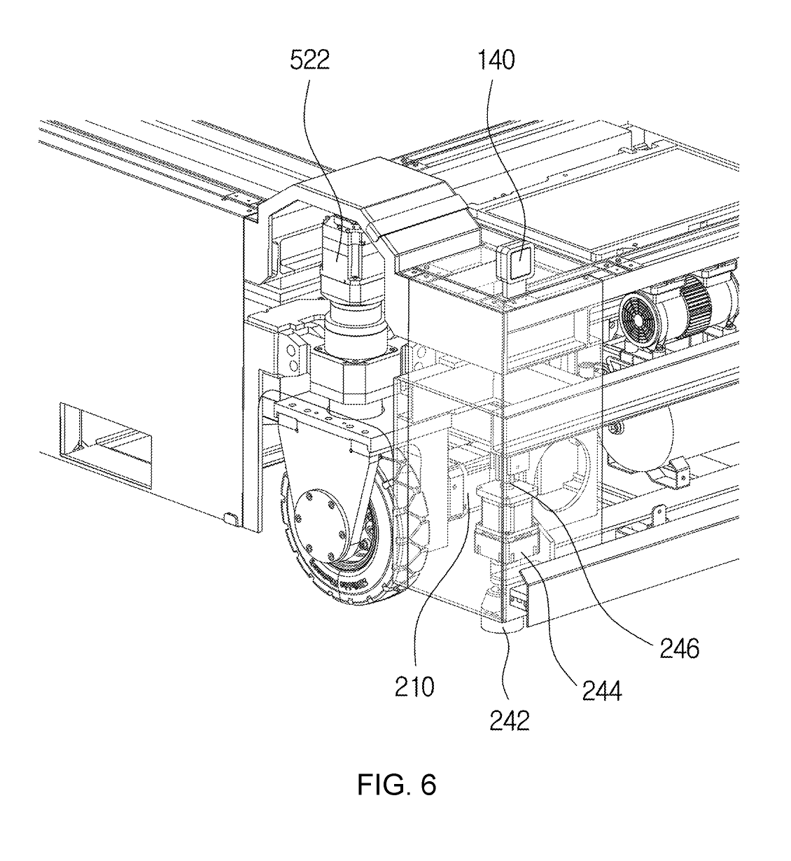

FIG. 6 illustrates an enlarged view of a lower traveling unit and a brush module of the autonomous blasting robot device 10 according to an embodiment.

According to an embodiment, the traveling unit may include the driving module 210 and the steering module 220. A floor brush 242, a brush driving motor 244, an angle-adjustable air cylinder 246, and an illumination lamp 140 may be disposed at a lower portion of the main frame 100.

In one embodiment, the driving module 210 may be disposed at a lower central portion of the main frame 100.

In one embodiment, the driving module 210 may include a driving motor and a reducer and may be configured to provide traveling power to the autonomous blasting robot device 10.

In one embodiment, rotational speed and torque of the driving motor may be controlled by the traveling motor drive 526.

In one embodiment, the steering module 220 may be disposed above the driving module 210.

In one embodiment, the steering module 220 may include a steering motor and a reducer and may be configured to change the direction of the autonomous blasting robot device 10.

In one embodiment, a steering angle of the steering module 220 may be controlled by the traveling motor drive 526.

In one embodiment, the floor brush 242 may be disposed at a lower end of the main frame 100.

In one embodiment, the floor brush 242 may be configured to remove foreign substances from the work surface.

In one embodiment, the floor brush 242 may be rotationally driven by the brush driving motor 244.

In one embodiment, the angle-adjustable air cylinder 246 may be connected to an upper portion of the floor brush 242.

In one embodiment, the air cylinder 246 may be configured to raise and lower the floor brush 242. For example, the air cylinder 246 may lower the floor brush 242 so as to bring the floor brush 242 into close contact with the work surface or may raise the floor brush 242 so as to separate it from the work surface.

In one embodiment, the air cylinder 246 may also function as an angle adjustment mechanism for adjusting an angle of the floor brush 242.

In one embodiment, the illumination lamp 140 may be disposed at a front or side portion of the main frame 100.

In one embodiment, the illumination lamp 140 may be configured to illuminate the surrounding area during work at night or inside a dark ship.

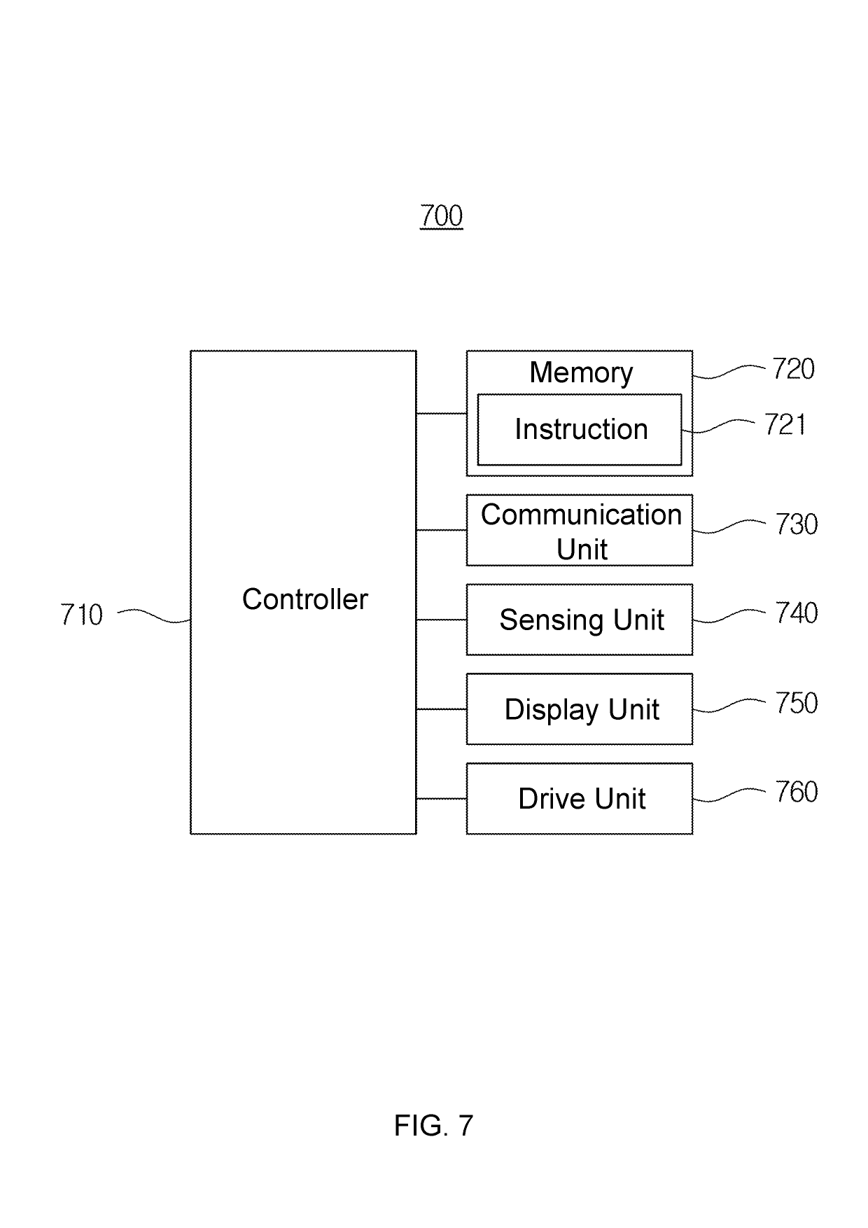

FIG. 7 illustrates a block configuration of an autonomous blasting robot according to an embodiment.

According to an embodiment, the autonomous blasting robot 10 may include a control unit 710, a memory 720, a communication unit 730, a sensing unit 740, a display unit 750, and a driving unit 760. An instruction 721 may be stored in the memory 720.

According to an embodiment, the memory 720 may be a storage medium used by the autonomous blasting robot and may store data such as at least one instruction or setting information corresponding to at least one program. The program may include an operating system program and various application programs.

In one embodiment, the memory 720 may store data received from an external electronic device located adjacent to the autonomous blasting robot, such as another autonomous blasting robot. For example, the data received from the external electronic device may include information on a work module, information on a work environment, and the like.

According to an embodiment, the communication unit 730 may provide a wired or wireless communication interface that enables communication with an external device, such as another vehicle, a control device, a relay device, or the like.

In one embodiment, the communication unit 730 may perform wireless short-range communication with an external device under control of the control unit 710. The short-range communication may include Bluetooth, Bluetooth Low Energy, infrared communication, ultra-wideband, near-field communication, and the like. The external device may include a control device, another autonomous blasting robot, a relay device, or a user device such as a smart phone or tablet PC.

In one embodiment, the control unit 710 may transmit data relating to traveling of the autonomous blasting robot to a control device through the communication unit 730. The data relating to traveling of the autonomous blasting robot may include image data acquired through a camera of the autonomous blasting robot, a speed of the autonomous blasting robot, information regarding a steering state, and the like.

In one embodiment, the control unit 710 may receive a remote work command from the control device through the communication unit 730.

According to an embodiment, the display unit 750 may provide information regarding a work state, a traveling state, an alarm, or a remote-control state of the autonomous blasting robot to an operator or a control device.

According to an embodiment, by executing at least one instruction stored in the memory 720, the control unit 710 may perform control of, communication with, or data processing for at least one other component of the autonomous blasting robot.

In one embodiment, the control unit 710 may include at least one of a central processing unit, a graphics processing unit, a microcontroller unit, a sensor hub, a supplementary processor, a communication processor, an application processor, an application-specific integrated circuit, or a field-programmable gate array, and may have a plurality of cores.

In one embodiment, the control unit 710 may execute software to control at least one other component of the autonomous blasting robot connected to the control unit 710, such as a hardware or software component, and may perform various data processing or calculations.

According to an embodiment, as at least a part of the data processing or calculation, the control unit 710 may store a command or data received from another component in volatile memory, process the command or data stored in the volatile memory, and store result data in nonvolatile memory.

According to an embodiment, the control unit 710 may include a main control unit, such as a central processing unit or application processor, or a supplementary control unit that is operable independently of or together with the main control unit, such as a graphics processing unit, a neural processing unit, an image signal processor, a sensor hub controller, or a communication processor. For example, when the autonomous blasting robot includes a main control unit and a supplementary control unit, the supplementary control unit may be configured to use lower power than the main control unit or may be specialized for a designated function. The supplementary control unit may be implemented separately from, or as a part of, the main control unit.

In one embodiment, the sensing unit 740 may include various types of sensors for detecting objects adjacent to the autonomous blasting robot and identifying a state of the autonomous blasting robot. For example, the sensing unit 740 may include one or more cameras, a LiDAR sensor, an inertial measurement unit sensor, a load sensor, a proximity sensor, and the like.

In one embodiment, the control unit 710 may recognize obstacles including ship block supports based on information obtained from the sensing unit 740 and may generate an avoidance path. For example, the control unit 710 may control the driving unit 760 to perform an avoidance maneuver based on autonomous-traveling labeling learning data according to the shape and size of a ship block support.

In one embodiment, the control unit 710 may be configured to vary the position of the blasting unit and the angle adjustment mechanism in response to a curved shape of the work surface. Accordingly, the blasting unit may perform uniform blasting work while maintaining a close-contact state with the work surface.

In one embodiment, the driving unit 760 may include components for movement of the autonomous blasting robot and control of a work module. Through the driving unit 760, the autonomous blasting robot may control traveling, direction adjustment, speed adjustment, and a specific operation of the work module.

According to one embodiment, an autonomous blasting robot device for surface treatment of a ship block may include a main frame having an internal mounting space, a traveling unit coupled to a lower portion of the main frame to perform traveling and steering, a blasting unit installed at an upper front portion of the main frame to spray grit or other abrasive media, a control unit disposed at a rear portion of the main frame and configured to control the traveling unit and the blasting unit, a main battery disposed inside or at a lower portion of the main frame to supply power, and a sensing unit including a camera and a LiDAR sensor for obstacle recognition.

In one embodiment, the blasting unit may include a blasting motor for grit spraying and a grit valve for adjusting a spray amount.

In one embodiment, the grit valve may be operated by at least one of an electric, hydraulic, pneumatic, or manual mechanism.

In one embodiment, a sealing blasting unit box, a scattering-prevention cover, and a brush for preventing outward scattering of grit may be disposed at a lower end of the blasting unit.

In one embodiment, the device may include a hydraulic unit and a hydraulic cylinder for adjusting a height of an upper plate of the blasting unit, a damper for maintaining close-contact force with the work surface, and an angle adjustment mechanism for adjusting a spray angle.

In one embodiment, the control unit may be configured to vary the position of the blasting unit and the angle adjustment mechanism in response to a curved shape of the work surface.

In one embodiment, inside the main frame, an air compressor for supplying compressed air to the blasting unit and a cooling system for cooling heat of internal equipment may be disposed. The cooling system may include a cooling water tank, a cooling water pump, a cooling radiator, and a cooling-water piping line connecting the same.

In one embodiment, the traveling unit may further include a plurality of casters for rotation and support, a guide caster for traveling guidance, a driving motor and a reducer for transmitting power, and a steering motor and a reducer for direction change.

In one embodiment, the device may include a floor brush installed at a lower end of the main frame to remove foreign substances, and an air cylinder configured to raise and lower the floor brush.

In one embodiment, the device may include a PDU for distributing power from the main battery, a reactor and a voltage filter for voltage stabilization, a blasting inverter and a main inverter for driving the blasting motor, and a motor drive for controlling the driving motor and the steering motor.

In one embodiment, an illumination lamp for nighttime work or work inside a dark ship may be installed at a front or side portion of the main frame, and the sensing unit may be configured to identify obstacles by preferentially using a vision camera rather than a LiDAR sensor in an environment in which grit is dispersed.

In one embodiment, the control unit may recognize obstacles including ship block supports based on information obtained from the sensing unit, generate an avoidance path, and perform an avoidance maneuver based on autonomous-traveling labeling learning data according to the shape and size of the ship block supports.

According to one embodiment, an autonomous blasting robot device for surface treatment of a work surface may include a main frame, a traveling unit movably coupled to the main frame, a blasting unit disposed at a front side of the main frame and configured to spray abrasive media toward the work surface, a scattering suppression unit surrounding at least a portion of the blasting unit and reducing outward scattering of the abrasive media, and a control unit configured to control the traveling unit and the blasting unit. The control unit may be configured to adjust at least one of a position, a height, a posture, or a spray angle of the blasting unit in response to a shape of the work surface.

In one embodiment, the scattering suppression unit may include at least one of a blasting unit box, a scattering-prevention cover, or a brush.

In one embodiment, the blasting unit may include a blasting motor for spraying abrasive media and a grit valve for adjusting a supply amount of the abrasive media.

In one embodiment, the grit valve may be operated by at least one of an electric, hydraulic, pneumatic, or manual mechanism.

In one embodiment, the blasting unit may include a lifting driving unit for adjusting the position of the blasting unit, an elastic support or damper for maintaining contact or a close-contact state with the work surface, and an angle adjustment mechanism for adjusting the spray angle.

In one embodiment, the lifting driving unit may include a hydraulic unit and a hydraulic cylinder.

In one embodiment, the robot device may further include a distance sensor for measuring a distance to the work surface or a front obstacle, and the control unit may be configured to adjust at least one of the position, height, posture, or spray angle of the blasting unit based on distance information obtained from the distance sensor.

In one embodiment, the distance sensor may include at least one of an ultrasonic sensor, a LiDAR sensor, or an optical distance sensor.

According to one embodiment, an autonomous blasting robot device may include a traveling unit, a sensing unit configured to obtain obstacle information, and a control unit configured to control the traveling unit. The control unit may be configured to identify obstacles including ship block supports in a shipyard work environment, generate an avoidance path based on a shape or size of the identified obstacle, and control the traveling unit.

In one embodiment, the sensing unit may include at least one of a camera, a LiDAR sensor, an ultrasonic sensor, or an inertial measurement unit.

In one embodiment, when reliability of a particular sensor is degraded due to dust or scattering of abrasive media, the control unit may be configured to identify an obstacle by applying greater weight to information from a sensor having relatively higher reliability among a plurality of sensors.

In one embodiment, the control unit may be configured to preferentially reflect camera-based image information rather than LiDAR sensor information in an environment in which abrasive media is dispersed.

In one embodiment, the control unit may identify at least one of a height, width, shape, or arrangement interval of an obstacle, and may determine an avoidance direction or avoidance distance according to the identification result.

In one embodiment, the control unit may classify the obstacle based on pre-constructed labeling learning data or an obstacle classification model and may perform an avoidance maneuver corresponding to the classified obstacle type.

In one embodiment, after obstacle avoidance, the control unit may generate a return path for returning to an original work path or a subsequent work path.

According to one embodiment, an autonomous blasting robot device may include a traveling unit, and a control unit configured to control the traveling unit, and the control unit may be configured to selectively perform at least two traveling modes among straight movement, turning movement, in-place rotation, parallel movement, and diagonal movement.

In one embodiment, when switching traveling modes, the control unit may be configured to change a control state of each driving unit or steering unit during a preset mode conversion time.

In one embodiment, the control unit may select a traveling mode based on at least one of a work situation, an obstacle position, a work path shape, or a work surface condition.

In one embodiment, in-place rotation may include a traveling mode in which the robot rotates about the center or a point near the center of the robot.

In one embodiment, parallel movement or diagonal movement may include a traveling mode in which the robot moves in a lateral or diagonal direction while maintaining a blasting work posture relative to the work surface.

According to one embodiment, an autonomous blasting robot device may include a communication unit and a control unit. The control unit may be configured to perform autonomous traveling or autonomous work while communicating with a remote device, and, when necessary, control at least one of traveling or blasting work according to a remote control command input from the remote device.

In one embodiment, the control unit may be configured to transmit state information through the communication unit so that one remote operator can simultaneously monitor state information of a plurality of autonomous blasting robots.

In one embodiment, the control unit may be configured to selectively allow remote manual control or semi-autonomous control intervention for a particular robot among a plurality of autonomous blasting robots.

In one embodiment, an air compressor for supplying compressed air to the blasting unit may be disposed inside the main frame.

In one embodiment, a cooling system including a cooling water tank, a cooling water pump, a cooling radiator, and a cooling-water piping line may be disposed inside the main frame.

In one embodiment, a floor brush for removing foreign substances from the work surface and an actuator for raising and lowering the floor brush may further be installed on the main frame.

In one embodiment, the actuator may include an air cylinder.

In one embodiment, an illumination lamp for illuminating a work region in a nighttime or low-light environment may be installed on the main frame.

In one embodiment, the robot device may further include a main battery, a power distribution unit for distributing power from the main battery, a reactor or voltage filter for voltage stabilization, an inverter for driving the blasting unit, and a motor drive for driving the traveling unit.

In one embodiment, the traveling unit may include a plurality of moving support portions, a driving motor and reducer, and a steering motor and reducer.

In one embodiment, the moving support portions may include a plurality of casters.

According to one embodiment, a control method of an autonomous blasting robot for surface treatment of a work surface may include obtaining work environment information through a sensing unit while traveling, identifying an obstacle from the obtained work environment information, generating a traveling path or an avoidance path based on the identified obstacle, adjusting at least one of a position, height, posture, or spray angle of a blasting unit based on a shape of the work surface or a distance to the work surface, selecting a traveling mode suitable for a work situation from among a plurality of traveling modes, receiving, when necessary, a control command from a remote device and intervening in at least one of traveling or blasting work, and performing surface treatment work by spraying abrasive media onto the work surface through the blasting unit.

In one embodiment, identifying the obstacle may include identifying a shape or size of an obstacle including a ship block support.

In one embodiment, obtaining work environment information may include acquiring information from a plurality of sensors, and identifying the obstacle may include applying different weights to the plurality of sensor information according to changes in sensor reliability caused by dust or scattering of abrasive media.

In one embodiment, adjusting the blasting unit may include controlling the position of the blasting unit so that a spacing from, or a contact state with, the work surface is maintained within a preset range.

In one embodiment, selecting the traveling mode may include selecting at least one of straight movement, turning movement, in-place rotation, parallel movement, or diagonal movement.

In one embodiment, after selecting the traveling mode, the method may further include converting a driving state or steering state during a preset conversion time.

The various embodiments described herein, and the terms used herein are not intended to limit the technical features described herein to specific embodiments, and should be understood to include various changes, equivalents, or substitutes of the corresponding embodiments. For example, a component expressed in the singular should be understood to include a plurality of components unless the context clearly indicates that only a singular component is intended.

The term "and/or" as used herein should be understood to encompass any and all possible combinations of one or more of the listed items. Terms such as "include," "have," and "comprise" are intended to specify the presence of the described features, components, parts, or combinations thereof, and are not intended to preclude the presence or addition of one or more other features, components, parts, or combinations thereof.

Expressions such as "A or B," "at least one of A and B," "at least one of A or B," "A, B, or C," "at least one of A, B, and C," and "at least one of A, B, or C" may include any one of the listed items or all possible combinations of the listed items. Terms such as "first," "second," "primary," or "secondary" may merely be used to distinguish one component from another component and do not limit the components in other respects, such as importance or order.

Terms such as "unit" or "module" used in various embodiments may include a unit implemented in hardware, software, or firmware, and may be used interchangeably with terms such as logic, logic block, part, or circuit. A unit or module may be an integrally configured part or a minimum unit or a portion of a part that performs one or more functions. For example, according to one embodiment, a unit or module may be implemented in the form of an application-specific integrated circuit.

The expression "when" or "if" a condition occurs, as used in various embodiments, may be interpreted, depending on context, as meaning "at the time of," "upon," "in response to determining," or "in response to detecting." Similarly, an expression such as "when it is determined that" or "when it is detected that" may be interpreted, depending on context, as meaning "upon determination," "in response to determining," "upon detection," or "in response to detecting."

A program executed by the autonomous blasting robot or by a control unit thereof may be implemented as hardware components, software components, or a combination of hardware and software components. The program may be performed by any system capable of executing computer-readable instructions.

Software may include a computer program, code, instructions, or one or more combinations thereof, and may configure a processing device to operate as desired or may command the processing device independently or collectively. The software may be implemented as a computer program including instructions stored on a computer-readable storage medium. Examples of computer-readable storage media include magnetic storage media such as read-only memory, random-access memory, floppy disks, and hard disks, and optical reading media such as CD-ROMs and digital versatile discs. The computer-readable storage medium may be distributed over network-connected computer systems so that computer-readable code is stored and executed in a distributed manner.

According to various embodiments, each component described above, such as a module or program, may include a single entity or a plurality of entities, and some of the plurality of entities may be separately disposed in another component. According to various embodiments, one or more of the components or operations described above may be omitted, or one or more other components or operations may be added.

Alternatively or additionally, a plurality of components, such as modules or programs, may be integrated into a single component. In such a case, the integrated component may perform one or more functions of each of the plurality of components in the same or a similar manner as was performed by the corresponding component before integration. According to various embodiments, operations performed by a module, program, or another component may be executed sequentially, in parallel, repeatedly, or heuristically, or one or more of the operations may be executed in a different order, omitted, or supplemented with one or more other operations.

What is claimed is:

1. An autonomous blasting robot device for surface treatment of a work surface, comprising:
a main frame having an internal mounting space;
a traveling unit coupled to a lower portion of the main frame and configured to perform traveling and steering;
a blasting unit disposed at a front portion of the main frame and configured to spray abrasive media toward the work surface;
a scattering suppression unit disposed around at least a portion of the blasting unit and configured to reduce outward scattering of the abrasive media;
a sensing unit configured to obtain information relating to the work surface and at least one obstacle in a work environment;
a control unit configured to control the traveling unit and the blasting unit; and
a main battery configured to supply electric power to at least one of the traveling unit, the blasting unit, the sensing unit, and the control unit,
wherein the control unit is configured to adjust at least one of a position, a height, a posture, and a spray angle of the blasting unit in response to a shape of the work surface.

2. The autonomous blasting robot device of claim 1, wherein the blasting unit comprises a blasting motor configured to spray the abrasive media, and a grit valve configured to adjust a supply amount of the abrasive media.

3. The autonomous blasting robot device of claim 2, wherein the grit valve is operable by at least one of an electric mechanism, a hydraulic mechanism, a pneumatic mechanism, and a manual mechanism.

4. The autonomous blasting robot device of claim 1, wherein the scattering suppression unit comprises at least one of a blasting unit box, a scattering-prevention cover, and a brush.

5. The autonomous blasting robot device of claim 1, wherein the blasting unit comprises a lifting driving unit configured to adjust the position or the height of the blasting unit, an elastic support or a damper configured to maintain a contact or close-contact state with the work surface, and an angle adjustment mechanism configured to adjust the spray angle.

6. The autonomous blasting robot device of claim 5, wherein the lifting driving unit comprises a hydraulic unit and a hydraulic cylinder.

7. The autonomous blasting robot device of claim 1, wherein the sensing unit comprises a distance sensor configured to measure a distance to the work surface or to the at least one obstacle, and wherein the control unit is configured to adjust at least one of the position, the height, the posture, and the spray angle of the blasting unit based on distance information obtained from the distance sensor.

8. The autonomous blasting robot device of claim 7, wherein the distance sensor comprises at least one of an ultrasonic sensor, a LiDAR sensor, and an optical distance sensor.

9. The autonomous blasting robot device of claim 1, wherein the sensing unit comprises at least one of a camera, a LiDAR sensor, an ultrasonic sensor, and an inertial measurement unit.

10. The autonomous blasting robot device of claim 1, wherein the control unit is configured to identify, in a shipyard work environment, a ship block support among the at least one obstacle, generate an avoidance path based on a shape or a size of the ship block support, and control the traveling unit according to the avoidance path.

11. The autonomous blasting robot device of claim 9, wherein, when reliability of one sensor among a plurality of sensors of the sensing unit is reduced due to dust or scattering of abrasive media, the control unit is configured to identify the at least one obstacle by applying greater weight to sensor information from another sensor among the plurality of sensors having relatively higher reliability.

12. The autonomous blasting robot device of claim 11, wherein the sensing unit comprises a camera and a LiDAR sensor, and wherein, in an environment in which the abrasive media is dispersed, the control unit is configured to preferentially reflect camera-based image information obtained by the camera over LiDAR sensor information obtained by the LiDAR sensor.

13. The autonomous blasting robot device of claim 10, wherein the control unit is configured to identify at least one of a height, a width, a shape, and an arrangement interval of the ship block support, and determine an avoidance direction or an avoidance distance according to an identification result.

14. The autonomous blasting robot device of claim 10, wherein the control unit is configured to classify the ship block support based on pre-constructed labeling learning data or an obstacle classification model and perform an avoidance maneuver corresponding to a classified obstacle type.

15. The autonomous blasting robot device of claim 10, wherein the control unit is configured to generate a return path for returning to an original work path or a subsequent work path after obstacle avoidance.

16. The autonomous blasting robot device of claim 1, further comprising at least one of an air compressor disposed inside the main frame and configured to supply compressed air to the blasting unit, a cooling system disposed inside the main frame and comprising a cooling water tank, a cooling water pump, a cooling radiator, and a cooling-water piping line, a floor brush installed on the main frame and configured to remove foreign substances from the work surface and an actuator configured to raise and lower the floor brush, an illumination lamp installed on the main frame and configured to illuminate a work region, a power distribution unit configured to distribute power from the main battery, a reactor or a voltage filter configured to stabilize voltage, an inverter configured to drive the blasting unit, and a motor drive configured to drive the traveling unit.

17. The autonomous blasting robot device of claim 1, wherein the traveling unit comprises a plurality of moving support portions, a driving motor and a driving reducer configured to transmit power, and a steering motor and a steering reducer configured to change a traveling direction, and wherein the plurality of moving support portions comprises a plurality of casters or a guide caster.

18. The autonomous blasting robot device of claim 1, wherein the control unit is configured to selectively perform at least two traveling modes among straight movement, turning movement, in-place rotation, parallel movement, and diagonal movement, select one of the at least two traveling modes based on at least one of a work situation, a position of the at least one obstacle, a work path shape, and a work surface condition, and, during switching between traveling modes, change a control state of a driving component or a steering component of the traveling unit during a preset mode conversion time.

19. The autonomous blasting robot device of claim 1, further comprising a communication unit configured to communicate with a remote device, wherein the control unit is configured to perform autonomous traveling or autonomous work while communicating with the remote device, receive a remote control command from the remote device, and control at least one of traveling and blasting work according to the remote control command, and wherein the communication unit is configured to transmit state information so that one remote operator can simultaneously monitor a plurality of autonomous blasting robot devices and selectively intervene in operation of a particular autonomous blasting robot device among the plurality of autonomous blasting robot devices.

20. A control method of an autonomous blasting robot device for surface treatment of a work surface, the control method comprising:
obtaining work environment information through a sensing unit while the autonomous blasting robot device travels;
identifying an obstacle from the work environment information;
generating a traveling path or an avoidance path based on the identified obstacle;
adjusting at least one of a position, a height, a posture, and a spray angle of a blasting unit based on a shape of the work surface or a distance to the work surface;
selecting a traveling mode from among straight movement, turning movement, in-place rotation, parallel movement, and diagonal movement based on a work situation;
receiving a remote control command from a remote device and intervening in at least one of traveling and blasting work according to the remote control command; and
performing surface treatment work by spraying abrasive media onto the work surface through the blasting unit.
